(19) United States
(12) Patent Application Publication
(10) Pub. No.: US 2021/0262617 A1
(43) Pub. Date: Aug. 26, 2021

(54) HIGH-PRESSURE VESSEL

(71) Applicant: MAGNA Energy Storage Systems GesmbH, Sinabelkirchen (AT)

(72) Inventors: David PUNTIGAM, Gross St.Florian (AT); Andreas PREITLER, Gratkorn (AT); Rainer PUCHLEITNER, Graz (AT)

(21) Appl. No.: 17/173,872

(22) Filed: Feb. 11, 2021

(30) Foreign Application Priority Data
Feb. 20, 2020 (EP) 20158506.4

(51) Int. Cl. F17C 1/16; F17C 1/06

(52) U.S. Cl. CPC F17C 1/16; F17C 1/06; F17C 2203/066; F17C 2203/0624; F17C 2201/0119

(57) ABSTRACT

A high-pressure container that includes a cylinder and at least one half-shell. The cylinder forms a middle region of the high-pressure container, and includes a multilayer composite plastic as a first barrier layer. The at least one half-shell is formed at an axial end of the cylinder, and includes a multilayer composite plastic as a second barrier layer, and a substantially rotationally symmetrical boss member having an undercut with respect to a protrusion in a direction of a longitudinal centre axis of the boss member. The multilayer composite plastic of the half-shell is arranged axially on both sides of the undercut of the boss member.

### CROSS-REFERENCE TO RELATED APPLICATIONS

The present application claims priority 35 U.S.C. § 119 to European Patent Publication No. EP 20158506.4 (filed on Feb. 20, 2020), which is hereby incorporated by reference in its entirety.

### TECHNICAL FIELD

One or more embodiments relate to a high-pressure container, in particular for storing a fuel for a motor vehicle.

### BACKGROUND

It is known that high-pressure containers, for example for storing hydrogen as fuel for motor vehicles, may be constructed from an internal layer, known as the liner, and a winding of fibre material around the liner.

To produce a container, it is known to use the technologies of blow-moulding and thermoforming. Production is then based on the shaping of hose-like or platform-like semifinished products. These are brought into their final shape by vacuum and/or positive pressure. For example, two half-shells may be produced which are joined together to form a container.

For the case of gas-tight liners for type IV containers which are used for pressurised storage of gases, there are two standard production methods. Firstly, blow-moulding of complete liners, and secondly the method of producing segments of the container in the injection-moulding and extrusion process, and subsequently connecting these components by a joining process.

The materials used here are normally based on HDPE (high density polyethylene) or polyamides.

Important distinguishing features for liner materials are the mechanical low-temperature properties and the emission properties. Mono-layer materials such as polyamide have a good barrier property for gases but do not have optimal low-temperature properties. On the other hand, HDPE does not have a suitable barrier effect but has excellent low-temperature properties.

For this reason, at present mainly polyamide is used for applications in the hydrogen sector in particular. However, above all for blow-moulding technology, this imposes limits with respect to component size. Because of their complex additive structure, the suitable types available are also costly and problematic for use at low temperatures.

High-pressure containers for gases are subject to great temperature fluctuations during operation (filling, storage and evacuation). These impose high requirements on the materials and in particular on the liner.

In connection with lightweight construction and the use of composite materials, in this context there arises the challenge of connecting the different materials together gas-tightly at the joining point.

### SUMMARY

It is an object of the invention to improve a high-pressure container in this respect, and in particular indicate a high-pressure container which meets the requirements for tightness and permeation for a high-pressure container even in a transitional region to a boss member, and at the same time is simple and economic to produce.

This object is achieved by a high-pressure container comprising a cylinder, forming a middle region of the high-pressure container, comprising a multilayer composite plastic as a first barrier layer; and at least one half-shell, at an axial end of the cylinder, comprising a multilayer composite plastic as a second barrier layer, a substantially rotationally symmetrical boss member having an undercut with respect to a protrusion in a direction of a longitudinal centre axis of the boss member, wherein the multilayer composite plastic of the half-shell is arranged axially on both sides of the undercut of the boss member.

An “undercut with respect to a protrusion in the direction of the longitudinal centre axis of the insert member” means that the insert member has a bulge which is further away from the longitudinal centre axis of the insert member than regions of the insert member which lie axially in front of and behind this bulge, so extraction of the insert member from plastic before and after this bulge or undercut is problematic in itself. The bulge or undercut may in particular have a greater diameter than regions of the insert member in front of and behind the undercut.

In accordance with one or more embodiments, the material used for the liner, both in the middle region formed by the cylinder and also in at least one and preferably both axial end regions of the container, is a multilayer composite. Such multilayer plastics can easily be moulded into half-shells via blow-moulding or deep-drawing or vacuum forming. The middle region of the cylinder may for example also be blow-moulded or for example extruded. According to the invention, a boss member is used which has an undercut with respect to a protrusion in the direction of the longitudinal centre axis of the insert member. Such an undercut is present if the insert member is formed wider in a region of its axial extent than in a region lying behind this which is also filled with plastic.

In accordance with one or more embodiments, the multilayer composite plastic is arranged on both sides of the undercut, axially in front of and behind the undercut. The usually metallic boss member is thus embedded in the plastic comprising the barrier layer. The high-pressure container thus has good permeation properties even in the region of the transition to the boss member. Economic production of the half-shell with embedded boss member and the entire high-pressure container is nonetheless possible since, as will be described in more detail below, despite the undercut, it is possible to introduce the plastic via blow-moulding or vacuum deep-drawing.

Preferably, the undercut is formed by a foot member on the end of the insert member which faces the container interior and has a greater diameter than a middle region of the insert member.

Preferably, the foot member has at least one groove which is filled with the multilayer composite plastic of the half-shell, preferably several grooves. The form-fit connection between the boss member and plastic of the liner can be improved by the presence of the plastic in the grooves. Preferably, the foot member substantially forms a hollow cone or hollow cylinder. Particularly preferably, at least one groove, filled with the multilayer composite plastic of the half-shell, extends around an inner circumference of the foot member.

Preferably, the multilayer composite plastic of the cylinder transforms into the multilayer composite plastic of the half-shell. The barrier layer preferably extends as continuously as possible at the transition between the cylinder and the half-shell.

The multilayer composite plastic of the half-shell, and preferably also the multilayer composite plastic of the cylinder, preferably comprises at least one layer of HDPE and a barrier layer, in particular EVOH, preferably also a regranulate, i.e., a regrind layer, and/or a second HDPE layer and/or at least one adhesion-promoting layer.

Preferably, the high-pressure container comprises two half-shells at the axial ends of the cylinder, wherein preferably both half-shells are configured as described for the first half-shell.

The cylinder and the two half-shells are preferably wrapped with a fibre material, preferably with a composite material comprising carbon fibres and/or glass fibres and/or epoxy resin.

In accordance with one or more embodiments, a high-pressure container may preferably be produced with a tool having a first tool half forming a die, wherein the method comprises the steps:

a preheated first plastic sheet is laid on the first tool half,

the first plastic sheet is drawn or pressed onto the first tool half via vacuum or pressure,

the plastic of the first plastic sheet is thereby arranged in regions behind an undercut of an insert member, namely the boss member, laterally spaced from the insert member; or after the first plastic sheet has been drawn or pressed onto the first tool half, the insert member is positioned such that plastic from the first plastic sheet is arranged in regions behind an undercut of the insert member, laterally spaced from the insert member,

then via a slider or a vacuum or a pressure, the plastic of the first plastic sheet is pressed or drawn onto the insert member behind the undercut, from laterally spaced from the insert member, so that a space behind the undercut of the insert member is filled with the plastic.

Preferably, in this way, the boss member is inserted in the tool as an insert member and, in a blow-moulding or deep-drawing process, surrounded by the plastic sheet, in particular a permeation-tight multilayer composite, so that the plastic also reaches regions behind an undercut. For this, firstly a plastic sheet is drawn or pressed onto the first tool half via vacuum or pressure. The insert member may already be positioned such that, by the drawing or pressing of the plastic onto the first tool half, the plastic of the first plastic sheet is arranged in regions behind an undercut of the insert member, laterally spaced from the insert member.

Alternatively, the insert member may be positioned only after drawing or pressing of the plastic onto the first tool half, such that plastic from the first plastic sheet is arranged behind the undercut, laterally spaced from the insert member, for example in that the insert member is moved or the insert member is only now introduced into the first tool half.

Then via a slider or a vacuum or a pressure, the plastic of the first plastic sheet is pressed or drawn onto the insert member from the side of the insert member, so that a space behind the undercut of the insert member is filled with plastic previously situated at the side, and a form-fit connection is created.

Thus, despite simple production via blow-moulding or vacuum-forming, the plastic also reaches regions behind the insert member; this ensures an improved sealing effect of the plastic, in particular the multilayer composite, onto the insert member, in particular the metallic boss member. To achieve the inclusion in the plastic, sliders and/or a vacuum or compressed air are used.

“Laterally spaced” here substantially means spaced from a longitudinal centre axis of the insert member which may preferably also coincide with the longitudinal centre axis of the pressure container. The plastic may initially extend substantially parallel to the longitudinal centre axis of the insert member, and preferably also to the surrounding container wall. The plastic is then drawn, blown or moved up to the insert member in a direction substantially normal to the longitudinal centre axis of the insert member, in particular radially inwardly on all sides.

To ensure that the plastic may be drawn or pressed onto the insert member temporally after the positioning of the insert member, so that the plastic is arranged laterally spaced from the insert member in regions, a continuous process may also be applied so that the insert member is moved on and positioned each time, and new plastic drawn or pressed on again, so that the insert member is positioned and the plastic drawn or pressed behind the undercut effectively simultaneously.

In a further step, the resulting half-shell may be connected to a second half-shell or to an extruded or blow-moulded multilayer cylinder. This forms the core and hence the basis for a further winding process, which gives the container its mechanical strength with a composite material of carbon and/or glass and epoxy resin.

Preferably, the tool comprises a second tool half forming a punch, wherein the second tool half is brought onto the first tool half in order to form the inner contour of the half-shell. The second tool half may, for this, shape the form of the first plastic sheet in the interior of the half-shell. The second tool half may instead also be provided with a second plastic sheet which forms the inner contour of the half-shell.

Preferably, after drawing or pressing of the first plastic sheet onto the first tool half, the insert member is raised relative to the first tool half in order to position the insert tool such that the plastic of the first plastic sheet is arranged behind the undercut, laterally spaced from the insert member. This raising may take place using a movable receiver for the insert member. The insert member may be arranged on the first plastic sheet on the container outer side, and the raising may thus take place along the longitudinal centre axis of the insert member and preferably also along the longitudinal centre axis of the high-pressure container, in particular in the direction towards the later centre of the container.

Preferably, after filling the space behind the undercut of the insert member with plastic, the insert member is lowered again relative to the first tool half. Particularly preferably, lowering takes place at the same time as the second tool half is moved onto the first tool half.

In accordance with one or more embodiments, the insert member is only laid on the first plastic sheet after the first plastic sheet has been drawn or pressed onto the first tool half, so as to position the insert member such that plastic from the first plastic sheet is arranged behind the undercut, laterally spaced from the insert member. The insert member may thus be arranged on the first plastic sheet on the container inner side. The second plastic sheet may again be arranged on the container inner side of the insert member.

The plastic of the first plastic sheet may be trimmed axially behind the plastic-filled space behind the undercut, so that no plastic remains behind the undercut, in particular on the container outer side of the undercut.

Preferably, a preheated second plastic sheet is laid on the second tool half, and then the second plastic sheet is drawn or pressed onto the second tool half via vacuum or pressure, and the second tool half with the second plastic sheet is moved onto the first tool half in order to form the inner contour of the half-shell.

Preferably, the first plastic sheet is a multilayer composite, wherein the multilayer composite preferably comprises a layer of HDPE (high-density polyethylene) and a barrier layer, in particular EVOH (ethylene vinyl alcohol copolymer). Particularly preferably, the multilayer composite also comprises a regrind material or regranulate and/or one or more adhesion-promoting layers. HDPE preferably forms the outermost layer of the multilayer composite and may also form the innermost layer.

A method for production of a high-pressure container preferably comprises production of a half-shell by a method as described above, wherein the half-shell is connected to a further half-shell—which for example may also comprise an insert member and be produced in the same manner as described above—or to at least one cylinder, preferably extruded or blow-moulded, and an end cap, in order to form a closed container.

The closed container is preferably wrapped with a fibre material, preferably with a composite material comprising carbon fibres and/or glass fibres and/or epoxy resin.

### DRAWINGS

One or more embodiments will be illustrated by way of example in the drawings and explained in the description hereinbelow.

FIGS. 1 through 6 illustrate sectional views of a method for producing a half-shell for a high-pressure container, in a first embodiment.

FIG. 7 illustrates a detail depiction of FIG. 3 in the region around the undercut of the insert member.

FIG. 8 illustrates a detail depiction of FIG. 4 in the region around the undercut of the insert member.

FIGS. 9 through 14 illustrate sectional views of a method for producing a half-shell for a high-pressure container, in a second embodiment.

FIG. 15 illustrates a sectional view of a high-pressure container in accordance with one or more embodiments.

### DESCRIPTION

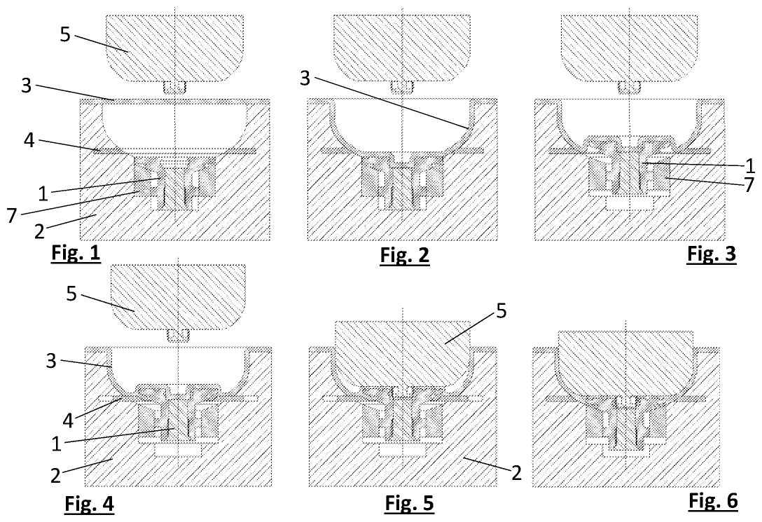

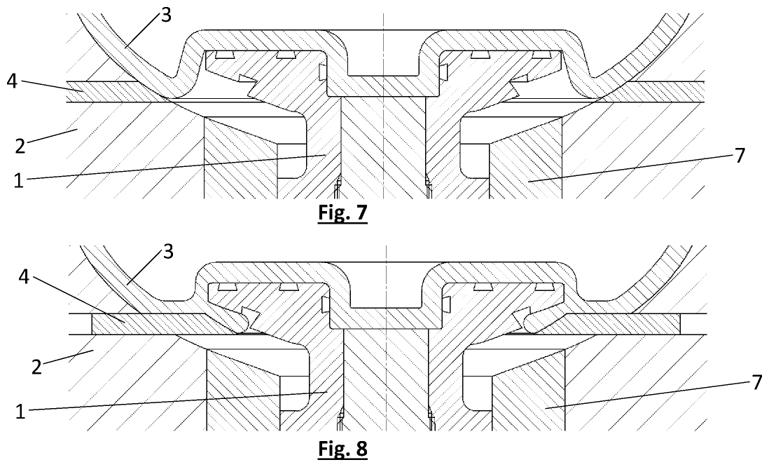

The illustrated embodiment of FIGS. 1 through 6 represent a method for production of a half-shell for a high-pressure container, in a first embodiment. A tool is used with a first tool half 2 which forms a die, and with a second tool half 5 which forms a punch. The tool thus comprises two tool halves, wherein the insert member is positioned on a movable receiver 7 in the first tool half 2, preferably the lower tool half. The second tool half 5, preferably the upper tool half, acts as a punch in order to apply a pressure at the end of the process. In addition, the second tool half 5 may also be provided with a second insert member. Using the sliders 4 provided in the tool and/or a vacuum, the plastic is brought to the points required for the form-fit connection.

For this, a preheated first plastic sheet 3 is laid on the first tool half 2, and the first plastic sheet 3 is drawn or pressed onto the first tool half 2 via vacuum or pressure. Then the insert member 1, i.e., the boss member, is positioned such that plastic from the first plastic sheet 3 is arranged in regions behind an undercut, laterally spaced from the insert member 1.

As illustrated in FIG. 3, alternatively, the movement of the insert member 1 may also be omitted, so that the plastic is drawn directly onto a correctly positioned insert member 1. Then via a slider 4 or a vacuum or a pressure, the plastic of the first plastic sheet 3 is pressed or drawn onto the insert member 1, behind the undercut from laterally spaced from the insert member 1, so that a space behind the undercut of the insert member 1 is filled with the plastic. Finally, the second tool half 5 is moved onto the first tool half 2 in order to form the inner contour of the half-shell.

In detail, the single-sheet method of FIGS. 1 through 6 comprises the following steps.

As illustrated in FIG. 1, in an initial step of the single-sheet method, the one tool half, namely the first tool half 2, is provided with the insert member 1, namely a boss member, and a preheated plastic sheet 3. The insert member 1 is in the starting position. Optionally at this point, the second tool half 5 may be provided with a further insert member. The plastic sheet 3 is drawn into the first tool half 2, forming the outer component geometry, via vacuum.

In order to fill with plastic the space necessary for the form-fit connection behind the undercut of the insert member 1, the insert member 1 is positioned on a movable receiver 7 in the first tool half 2.

As illustrated in FIGS. 3 and 4, by raising the component and for example simultaneous use of a vacuum and/or sliders 4, the space behind the undercut of the component is filled.

As illustrated in FIG. 5, in the next step, the second tool half 5 is lowered onto the first tool half 2 with a defined closing force, forming the inner contour of the component. During this process step, the insert member 1 may in some cases be returned to the starting position. In this way, the plastic is additionally pressed behind the undercuts, and the form-fit connection between the insert member 1 and the plastic of the first plastic sheet 3 is improved.

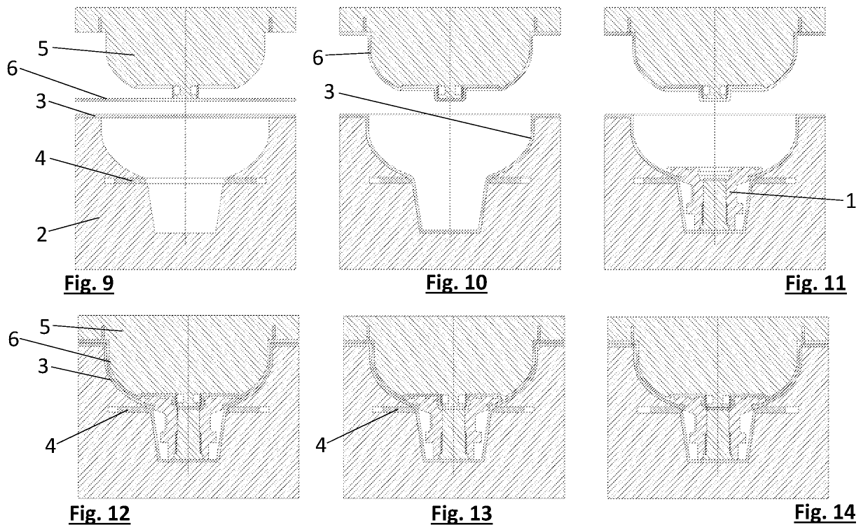

The illustrated embodiment of FIGS. 9 through 14 represent an alternative embodiment of the production method, namely a twin-sheet method for production of a half-shell.

As illustrated in FIG. 9, in an initial step of the twin-sheet method, both tool halves 2, 5 are provided with a preheated plastic sheet 3, 6. Optionally, at this point also the second tool half 5 may be provided with an insert member.

As illustrated in FIG. 10, the plastic sheets 3, 6 are drawn into or onto the respective tool halves 2, 5, forming the outer and inner component geometry respectively, via vacuum.

As illustrated in FIG. 11, in the next step, the insert member 1 to be surrounded is laid in the first tool half 2.

As illustrated in FIG. 12, via a vacuum and/or sliders 4, the space behind the undercut of the insert member 1 necessary for the form-fit connection is filled with plastic.

As illustrated in FIG. 13, the surplus material is cut off behind the undercut by the cutting edges introduced into the tool. These cutters may, as in FIG. 3, also be contained in the sliders 4.

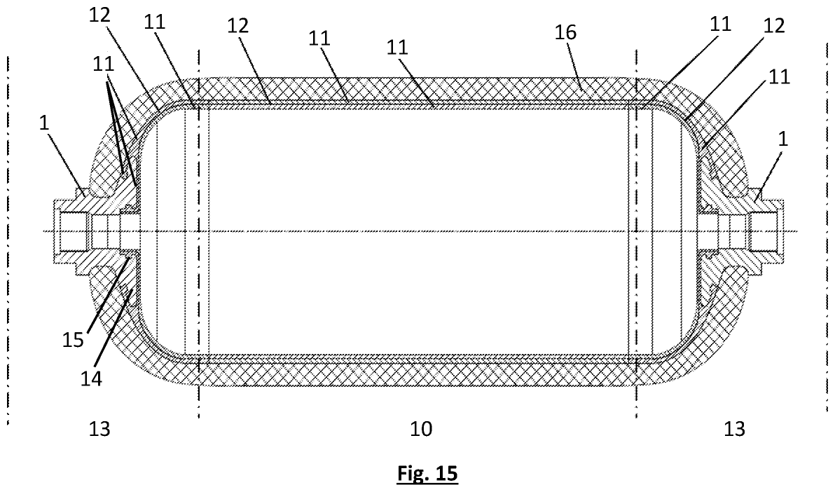

As illustrated in FIG. 14, the finished component is represented, wherein the surplus plastic below the undercut and the slider 4 has been cut away.

As illustrated in FIG. 15, a high-pressure container is represented in accordance with one or more embodiments. The high-pressure container comprises a cylinder 10 as a middle region, wherein the cylinder 10 comprises a multilayer composite plastic 11 which comprises a barrier layer 12, wherein the high-pressure container furthermore comprises at least one half-shell 13 at an axial end of the cylinder 10, wherein the half-shell 13 comprises a multilayer composite plastic 11 comprising a barrier layer 12, wherein the half-shell 13 furthermore comprises a substantially rotationally symmetrical insert member 1, namely a boss member, wherein the insert member 1 comprises an undercut with respect to a protrusion in the direction of the longitudinal centre axis of the insert member 1, wherein the multilayer composite plastic 11 of the half-shell 13 is arranged axially on both sides of the undercut of the insert member 1.

The undercut is formed by a foot member 14 on the end of the insert member 1 facing the container interior, and has a greater diameter than a middle region of the insert member 1. The multilayer composite plastic 11 is axially arranged on both sides of the foot member 14. The foot member 14 has several grooves 15 which are filled with the multilayer composite plastic 11 of the half-shell 13.

The insert member 1 has substantially the shape of a hollow cylinder. The foot member 14 has substantially the shape of a hollow cone.

A groove 15, filled with the multilayer composite plastic 11 of the half-shell 13, extends around the inner circumference of the foot member 14. The multilayer composite plastic 11 of the cylinder 10 transforms into the multilayer composite plastic 11 of the half-shell 13.

The multilayer composite plastic 11 of the half-shell 13 and also of the cylinder 10 comprises a layer of HDPE as the outermost layer and a barrier layer 12 of EVOH. The HDPE may be present as HDPE-S (Schwarz), followed by a regranulate layer, an adhesion-promoting agent, the EVOH layer, optionally a further adhesion-promoting agent and optionally also a further HDPE layer as the innermost layer.

The high-pressure container comprises two half-shells 13 at the axial ends of the cylinder 10, wherein the two half-shells 13 are configured as described above, i.e., they have a boss member 1 which is embedded in the multilayer composite plastic

The cylinder 10 and the two half-shells 13 are wrapped with a fibre material 16, preferably a composite material comprising carbon fibres and/or glass fibres and/or epoxy resin.

Overall, thus a high-pressure container is produced which may serve for storage of gases under high pressure. It is produced as a lightweight structure and has a multipiece, multilayer plastic liner consisting of two dome caps 13 and a cylinder 10, which ensures the gas-tightness and contains a permeation barrier 12.

Boss members 1, namely a headstock and a tailstock, are integrated in the two dome caps 13. The permeation properties are provided by a blocking or barrier layer 12 which is contained in the layer structure of the liner, both in the dome caps 13 and also in the cylinder tube 10. The high-pressure container obtains its mechanical strength from a fibre-reinforced composite 16 which is applied to the plastic liner in the winding process and then hardened.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 Insert member, boss member
2 First tool half
3 First plastic sheet
4 Slider
5 Second tool half
6 Second plastic sheet
7 Receiver
10 Cylinder
11 Multilayer composite plastic
12 Barrier layer
13 Half-shell
14 Foot member
15 Groove
16 Fibre material

What is claimed is:

1. A high-pressure container, comprising:
a cylinder, forming a middle region of the high-pressure container, comprising a multilayer composite plastic as a first barrier layer; and
at least one half-shell, at an axial end of the cylinder, comprising a multilayer composite plastic as a second barrier layer, and a substantially rotationally symmetrical boss member having an undercut with respect to a protrusion in a direction of a longitudinal centre axis of the boss member, wherein the multilayer composite plastic of the half-shell is arranged axially on both sides of the undercut of the boss member.

2. The high-pressure container of claim 1, wherein the undercut is formed by a foot member on the end of the boss member which faces the container interior, the foot member having a diameter greater than a diameter of a middle region of the boss member.

3. The high-pressure container of claim 2, wherein the foot member has at least one groove which is filled with the multilayer composite plastic of the half-shell.

4. The high-pressure container of claim 3, wherein the foot member has a plurality of grooves which are filled with the multilayer composite plastic of the half-shell.

5. The high-pressure container of claim 2, wherein the foot member substantially forms a hollow cone or hollow cylinder, and has at least one groove which is filled with the multilayer composite plastic of the half-shell, and extends around an inner circumference of the foot member.

6. The high-pressure container of claim 1, wherein the multilayer composite plastic of the cylinder transforms into the multilayer composite plastic of the half-shell.

7. The high-pressure container of claim 1, wherein the multilayer composite plastic of the half-shell comprises at least one layer of HDPE and a third barrier layer comprising EVOH.

8. The high-pressure container of claim 7, wherein the multilayer composite plastic of the half-shell comprises one or more of a regranulate, a second HDPE layer, and at least one adhesion-promoting layer.

9. The high-pressure container of claim 1, further comprising two half-shells at the axial ends of the cylinder.

10. The high-pressure container of claim 9, wherein the cylinder and the two half-shells are encapsulated with a fibre material comprising a composite material having one or more of carbon fibres, glass fibres, and epoxy resin.
